(19) United States
(12) Patent Application Publication
(10) Pub. No.: US 2016/0031084 A1
(43) Pub. Date: Feb. 4, 2016

(54) DOUBLE ARM ROBOT

(71) Applicant: Seiko Epson Corporation, Tokyo (JP)

(72) Inventor: Takema YAMAZAKI, Fujimi (JP)

(21) Appl. No.: 14/802,357

(22) Filed: Jul. 17, 2015

(30) Foreign Application Priority Data
Jul. 31, 2014 (JP) 2014-155646

(51) Int. Cl. B25J 9/16; B25J 9/00

(52) U.S. Cl. CPC B25J 9/1682; B25J 9/0096; B25J 9/1676; Y10S 901/27; Y10S 901/19; Y10S 901/02

(57) ABSTRACT

There is provided a double arm robot having a first arm to which a first end effector is attached and a second arm to which a second end effector is attached. The first arm and the second arm are different from each other in at least one of an arm length, an arm thickness, an arm surface shape, an arm surface color, an arm surface pattern, the number of arm joints, an arm joint shape, a shape of accessory components disposed on an arm surface, an arrangement of the accessory components, and the number of the accessory components.

### BACKGROUND

1. Technical Field

The present invention relates to a double arm robot.

2. Related Art

In recent years, a double arm robot has been developed which has double arms and which can carry out various work tasks such as transportation or assembly of a component by respectively driving each arm. For example, JP-A-2006-167902 discloses a double arm robot which is configured so as to select an arm for manipulating an object from right and left arms according to a position of the object. In addition, Japanese Patent No. 5305174 discloses a double arm robot which mixes a sample inside a plate while gripping a spatula with one hand and gripping the plate with the other hand between hands of two arms. In addition, Japanese Patent No. 5167548 discloses a double arm robot which decreases an output of a motor for actuating a joint of a work arm carrying out work, when recognizing that work for a workpiece is work to be carried out together in cooperation with a person (for example, recognizing that there is a possibility of interference between a robot and a person), based on an image captured by imaging means.

Incidentally, it is conceivable that production efficiency is improved in such a way that a work space is shared between a person (hereinafter, referred to as a “worker”) and a robot or between a robot and another robot so as to concurrently carry out work together, or that the work is carried out together in cooperation with each other, that is, in such a way that joint work is carried out by sharing the work space between the person and the robot or between the robot and another robot.

However, a general robot in the related art, for example, the robots disclosed in JP-A-2006-167902 and Japanese Patent No. 5305174 are set so that the two arms have an equal operation area, an equal operation speed, and an equal structure. For this reason, when the robot having this configuration and the person carry out the joint work together, safety of the worker is not sufficiently ensured, and the joint work is not smoothly carried out. Therefore, it is desirable to ensure the safety of the worker who carries out the joint work, and to ensure smooth work. In addition, similarly, when a robot and another robot carry out the joint work together, it is also desirable to ensure smooth work by reliably avoiding suspension of the work or a failure of the robot which is caused by a stopped operation of the robot due to interference such as contact between the robots, for example (hereinafter, referred to as “robot safety”). Furthermore, when the worker carrying out the joint work or another robot enters and leaves from the work space for the purpose of shift work, it is also desirable to smoothly carry out the shift work, to exclude unnecessary work, and to improve work efficiency.

The robot disclosed in Japanese Patent No. 5167548 is configured so that an image captured by imaging means is necessary to be recognized in order for the worker and the robot to carry out the joint work, thereby causing a problem in that a complicated configuration therefor is necessary. Therefore, it is also desirable to ensure smooth work by using a more simplified configuration and ensuring safety of a worker or another robot when there is a possibility of interference between the robot and the worker or another robot.

### SUMMARY

An advantage of some aspects of the invention is to solve at least a part of the problems described above, and the invention can be implemented as the following forms.

(1) An aspect of the invention provides a double arm robot including a first arm to which a first end effector is attached and a second arm to which a second end effector is attached. In the double arm robot, the first arm and the second arm are different from each other in at least one of an arm length, an arm thickness, an arm surface shape, an arm surface color, an arm surface pattern, the number of arm joints, an arm joint shape, a shape of accessory components disposed on an arm surface, an arrangement of the accessory components, and the number of the accessory components.

According to the double arm robot of the aspect of the invention, for example, when the first arm is operated in a work space (also referred to as a “work area”) where joint work is carried out, since appearance of the first arm is different from appearance of the second arm, movement of the first arm which is likely to interfere with a worker becomes very noticeable. Accordingly, the worker can carry out the work while carefully watching the movement of the first arm. It is possible to ensure safety of the worker who carries out the joint work by preventing the first arm from interfering with the worker. In addition, it is possible to ensure smooth work which is carried out by the worker or another robot.

(2) In the double arm robot of the aspect of the invention described above, a size of a work area for the first arm may be different from a size of a work area for the second arm.

According to the double arm robot of the aspect of the invention described above, both the appearance and the size of the work area of the first arm are different from the appearance and the size of the work area of the second arm. Accordingly, for example, when the first arm is operated in the work space (work area) where the joint work is carried out, movement of the first arm which is likely to interfere with the worker becomes very noticeable due to the difference in the appearance and the work area of the first arm. In this manner, the worker can carry out the work while carefully watching the movement of the first arm. It is possible to ensure safety of the worker who carries out the joint work by preventing the first arm from interfering with the worker. In addition, it is possible to ensure smooth work which is carried out by the worker or another robot.

(3) In the double arm robot according to the aspect of the invention described above, the work area of the first arm may overlap a portion of a work area of a worker or another robot, which is disposed beside or in front of the first arm, and the work area of the second arm may not overlap the work area of the worker or another robot.

According to the double arm robot of the aspect of the invention described above, the work area of the first arm overlaps a portion of the work area of the worker or another robot, which is disposed beside or in front of the first arm, and in a portion of the work area of the first arm which is likely to interfere with the worker, movement of the first arm which is likely to interfere with the worker becomes very noticeable due to the difference in the appearance and the work area of the arms. In this manner, for example, the worker can carry out the work while carefully watching the movement of the first arm. It is possible to ensure safety of the worker who carries out the joint work by preventing the first arm from interfering with the worker. In addition, it is possible to ensure smooth work which is carried out by the worker or another robot.

(4) The double arm robot according to the aspect of the invention described above may further include a first drive mechanism that drives the first arm and a second drive mechanism that drives the second arm, and a size difference between the work area of the first arm and the work area of the second arm may be made due to a difference between the first drive mechanism and the second drive mechanism.

According to the double arm robot of the aspect of the invention described above, a difference between the work area of the first arm and the work area of the second arm can be practically made by using the first drive mechanism and the second drive mechanism.

(5) The double arm robot according to the aspect of the invention described above may further include a control unit that controls each operation of the first arm and the second arm, and a size difference between the work area of the first arm and the work area of the second arm may be made due to a difference between the control of the first arm and the control of the second arm by the control unit.

According to the double arm robot of the aspect of the invention described above, a difference between the work area of the first arm and the work area of the second arm can be practically made by the control unit controlling the operation of the first arm and the second arm.

(6) Another aspect of the invention provides a double arm robot including a first arm to which a first end effector is attached and a second arm to which a second end effector is attached. In the double arm robot, the first arm and the second arm may be different from each other in at least one of an arm length, an arm thickness, an arm surface shape, the number of arm joints, a movable angle of a joint, arm plasticity or flexibility, a drive mechanism for driving the arm, and a motor included in the drive mechanism. A size of a work area for the first arm may be different from a size of a work area for the second arm.

According to the double arm robot of the aspect of the invention described above, for example, when the first arm is operated in the work space (work area) where joint work is carried out, movement of the first arm which is likely to interfere with the worker becomes very noticeable due to a difference in the structure and the work area of the first arm. In this manner, the worker can carry out the work while carefully watching the movement of the first arm. It is possible to ensure safety of the worker who carries out the joint work by preventing the first arm from interfering with the worker. In addition, it is possible to ensure smooth work which is carried out by the worker or another robot.

(7) In the double arm robot according to the aspect of the invention described above, the work area of the first arm may overlap a portion of a work area of a worker or another robot, which is disposed beside or in front of the first arm, and the work area of the second arm may not overlap the work area of the worker or another robot.

According to the double arm robot of the aspect of the invention described above, the work area of the first arm overlaps a portion of the work area of the worker or another robot, which is disposed beside or in front of the first arm, and in a portion of the work area of the first arm which is likely to interfere with the worker, movement of the first arm which is likely to interfere with the worker becomes very noticeable due to the difference in the structure and the work area of the arms. In this manner, for example, the worker can carry out the work while carefully watching the movement of the first arm. It is possible to ensure safety of the worker who carries out the joint work by preventing the first arm from interfering with the worker. In addition, it is possible to ensure smooth work which is carried out by the worker or another robot.

(8) The double arm robot according to the aspect of the invention described above may further include a first drive mechanism that drives the first arm and a second drive mechanism that drives the second arm. A size difference between the work area of the first arm and the work area of the second arm may be made due to a difference between the first drive mechanism and the second drive mechanism.

According to the double arm robot of the aspect of the invention described above, a difference between the work area of the first arm and the work area of the second arm can be practically made by using the first drive mechanism and the second drive mechanism.

(9) The double arm robot according to the aspect of the invention described above may further include a control unit that controls each operation of the first arm and the second arm, and a size difference between the work area of the first arm and the work area of the second arm may be made due to a difference between the control of the first arm and the control of the second arm.

According to the double arm robot of the aspect of the invention described above, a difference between the work area of the first arm and the work area of the second arm can be practically made by the control unit controlling the operation of the first arm and the second arm.

(10) The double arm robot according to the aspect of the invention described above may further include a base and a trunk that is rotatably connected to the base, and the first arm and the second arm may be respectively connected to the trunk on both sides of the trunk.

(11) Still another aspect of the invention provides a double arm robot including a first arm to which a first hand is attached and a second arm to which a second hand is attached. The double arm robot includes a detection unit that detects the presence or absence of a worker or another robot carrying out work in a work area of the worker and another robot, which is disposed beside or in front of the first arm. When the detection unit is switched from a detection state to a non-detection state, an operation of the double arm robot is stopped.

According to the double arm robot of the aspect of the invention described above, when the worker or another robot carrying out the work in the work area is absent, the operation of the double arm robot is stopped. Accordingly, it is possible to exclude an unnecessary operation which continues regardless if the worker or another robot carrying out joint work is absent.

(12) Yet another aspect of the invention provides a double arm robot including a first arm to which a first hand is attached and a second arm to which a second hand is attached. The double arm robot includes a detection unit that detects the presence or absence of a worker or another robot carrying out work in a work area. When the detection unit is switched from a non-detection state to a detection state, an operation of the double arm robot is started.

According to the double arm robot of the aspect of the invention described above, when the worker or another robot carrying out the work in the work area is present, the operation of the double arm robot is started. Accordingly, it is possible to improve work efficiency.

### BRIEF DESCRIPTION OF THE DRAWINGS

The invention will be described with reference to the accompanying drawings, wherein like numbers reference like elements.

FIG. 1 is a perspective view illustrating a robot according to a first embodiment of the invention.

FIG. 2 is an explanatory view for illustrating an end effector attached to an articulated arm of the robot.

FIG. 3 is an explanatory view for illustrating a work area of the robot for joint work, where a worker is arranged beside the robot.

FIG. 4 is an explanatory view for illustrating a work area of the worker in addition to the work area of the robot illustrated in FIG. 3.

FIG. 5 is an explanatory view for illustrating another example of the work area of the robot for joint work when the worker is arranged beside the robot.

FIG. 6 is an explanatory view for illustrating an example of the work area of the robot for joint work when the worker is arranged in front of the robot so as to oppose the robot.

FIG. 7 is an explanatory view for illustrating an example of the work area of the robot when another robot is arranged instead of the worker.

FIG. 8 is a schematic configuration diagram illustrating a joint mechanism and a rotary shaft of the robot.

FIG. 9 is a block diagram illustrating a control system of the robot.

FIG. 10 is a block diagram illustrating a first drive source control unit within a robot control device which performs drive control for the robot.

FIG. 11 is a perspective view illustrating a robot according to a second embodiment of the invention.

### DESCRIPTION OF EXEMPLARY EMBODIMENTS

### A. Definition of Terms

In the description, the following terms are used.
Length of Arm (Arm Length): defined as a length from a joint of a base to a wrist joint excluding an end effector, which is obtained by extending an arm of a robot so as to be parallel to a floor surface.
Thickness of Arm: defined as the maximum value in a thickness direction particularly including the joint in the arm length.
Surface Shape of Arm: defined as a shape of a circumferential surface in arm length and arm thickness directions. The surface shape of the arm also includes a surface shape of the joint.
Surface Color of Arm: defined as a color of the circumferential surface in the arm length and arm thickness directions. The surface color of the arm also includes a surface color of the joint. In addition, the surface color includes an active color generated by a light emitting member and a dynamic color change made intentionally, for example, flashing of an LED and a color change from red to blue.
Surface Pattern of Arm: defined as a pattern of the circumferential surface in the arm length and arm thickness directions. The surface pattern of the arm also includes a surface pattern of the joint. In addition, the surface pattern of the arm includes an active pattern change made by the light emitting member or a display member and a dynamic pattern change made intentionally, for example, a change in the lighting number of LED indicators installed in a main joint (for example, indicating a difference in output power) and warning (warning color) display by using liquid crystal.
Number of Arm Joints: defined as a total number of arm joints.
Movable Angle of Joint: defined as a total angle at which the arm joints are movable.
Joint Shape of Arm: defined as a shape on an entire outer peripheral surface of the arm joints.
Plasticity or Flexibility of Arm: intended to mean a state of maintaining durability without being affected by movable characteristics of the arm even if a shape is changed by receiving mechanical stress from an external force, and a state except for a state where performance becomes poor due to the shape change is defined as flexibility or plasticity.
Movable Area of Arm: defined as a spatial area where the arm can be operated.
Work Area of Arm: defined as a spatial area where an end effector attached to the arm can be operated.

### B. First Embodiment

### B1. Configuration of Robot

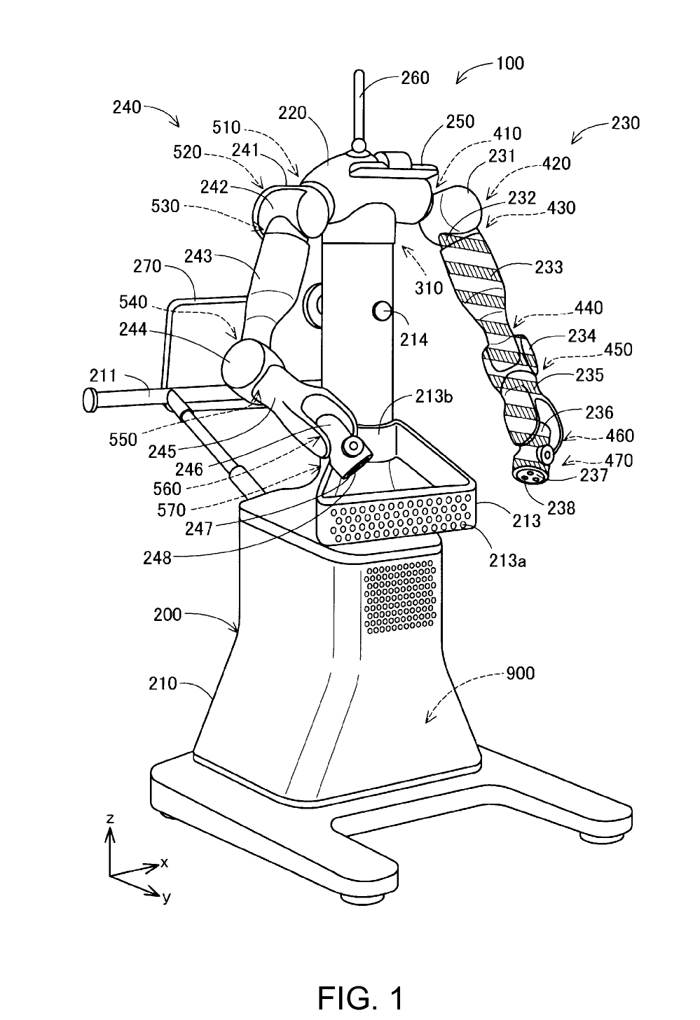

FIG. 1 is a perspective view illustrating a robot 100 according to a first embodiment of the invention. The robot 100 includes a robot main body 200 and a robot control device 900 (also referred to as a “control unit 900”) which controls an operation of the robot main body 200.

The robot 200 is a double arm robot, and has a base 210, a trunk 220 which is connected to the base 210, and a first articulated arm (simply referred to as a “first arm”) 230 and a second articulated arm (simply referred to as a “second arm”) 240 which can be operated by being respectively disposed on both right and left sides of the trunk 220. In addition, the robot main body 200 has a stereo camera 250 which is disposed on a front surface of the trunk 220, hand cameras (not illustrated) which are respectively disposed in the first articulated arm 230 and the second articulated arm 240, a signal lamp 260 which is disposed in the trunk 220, and a monitor 270 which is disposed on a rear surface side of the trunk 220.

The base 210 has multiple wheels (rotary members) which facilitate movement of the robot 100, a locking mechanism (not illustrated) which locks each wheel, and a handle (grip portion) 211 which is gripped when the robot 100 is moved. The robot 100 can be freely moved by unlocking the locking mechanism and by gripping and pushing or pulling the handle 211. The robot 100 can be fixed at a predetermined position by causing the locking mechanism to lock the wheels. In this manner, convenience of the robot 100 is improved by facilitating the movement of the robot 100. The wheels, the locking mechanism, and the handle 211 may be respectively omitted. In addition, the base 210 has a bumper 213 for coming into contact with a work table (not illustrated). The bumper 213 is brought into contact with a side surface of the work table, thereby enabling the robot 100 to oppose the work table by leaving a predetermined distance therebetween. In this manner, it is possible to prevent the robot 100 from unintentionally coming into contact with the work table. In addition, the base 210 has an emergency stop button 214. The robot 100 can be urgently stopped by pushing the emergency stop button 214 in case of an emergency.

The trunk 220 is connected via a waist joint mechanism 310 to a center shaft (not illustrated) serving as a rotary shaft of the base 210 so as to be rotatable around the rotary shaft. In addition, as described above, the trunk 220 has the stereo camera 250 and the signal lamp 260.

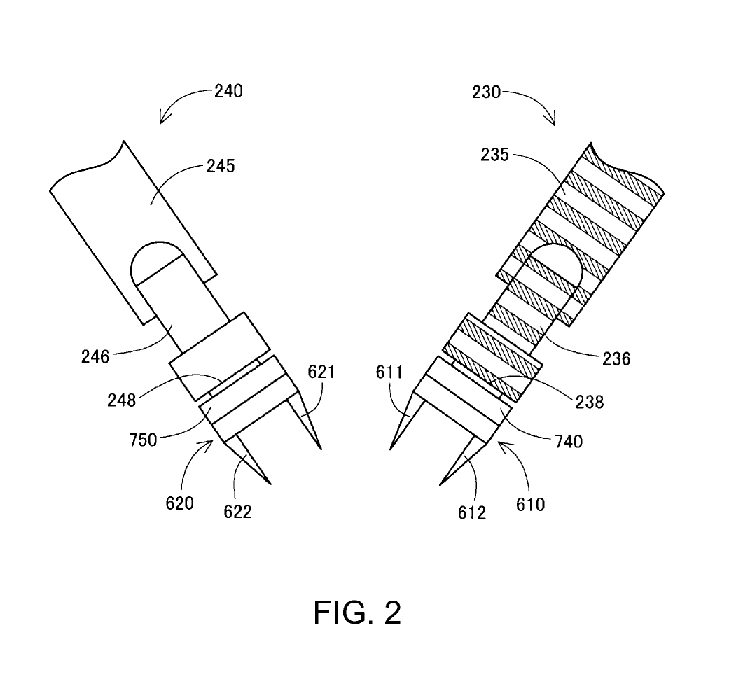

The first articulated arm 230 has a first shoulder joint mechanism 410, a first shoulder 231, a second shoulder joint mechanism 420, a second shoulder 232, an upper arm twist mechanism 430, an upper arm 233, an elbow joint mechanism 440, a first front arm 234, a front arm twist mechanism 450, a second front arm 235, a wrist joint mechanism 460, a wrist 236, a wrist twist mechanism 470, and a connection portion 237 which are connected sequentially from the trunk 220. The joint mechanisms 410, 420, 440, and 460 are bending joint mechanisms, and the twist mechanisms 430, 450, and 470 are twisting joint mechanisms. Then, the connection portion 237 has an end effector attachment portion 238. As illustrated in FIG. 2, a first end effector 610 according to work to be carried out by the robot 100 is attached to the end effector attachment portion 238 via a force sensor 740.

The second articulated arm 240 has the same configuration as the first articulated arm 230. That is, the second articulated arm 240 has a first shoulder joint mechanism 510, a first shoulder 241, a second shoulder joint mechanism 520, a second shoulder 242, an upper arm twist mechanism 530, an upper arm 243, an elbow joint mechanism 540, a first front arm 244, a front arm twist mechanism 550, a second front arm 245, a wrist joint mechanism 560, a wrist 246, a wrist twist mechanism 570, and a connection portion 247 which are connected sequentially from the trunk 220. Then, the connection portion 247 has an end effector attachment portion 248. As illustrated in FIG. 2, a second end effector 620 according to work to be carried out by the robot 100 is attached to the end effector attachment portion 248 via a force sensor 750.

The first articulated arm 230 can be operated in directions (three-dimensions) of three axes (x, y, and z) which are orthogonal to one another by seven joint mechanisms such as the first shoulder joint mechanism 410, the second shoulder joint mechanism 420, the upper arm twist mechanism 430, the elbow joint mechanism 440, the front arm twist mechanism 450, the wrist joint mechanism 460, and the wrist twist mechanism 470. Similarly, the second articulated arm 240 can also be operated in the directions of the three axes which are orthogonal to one another by seven joint mechanisms such as the first shoulder joint mechanism 510, the second shoulder joint mechanism 520, the upper arm twist mechanism 530, the elbow joint mechanism 540, the front arm twist mechanism 550, the wrist joint mechanism 560, and the wrist twist mechanism 570. In this manner, a relatively simple configuration enables the first articulated arm 230 and the second articulated arm 240 to practically twist the upper arm and the front arm by the bending and extending joints (shoulder, elbow, and wrist) similarly to those of human arms.

In some cases, the first shoulder joint mechanism 410, the second shoulder joint mechanism 420, the upper arm twist mechanism 430, the elbow joint mechanism 440, the front arm twist mechanism 450, the wrist joint mechanism 460, and the wrist twist mechanism 470 of the first articulated arm 230 are simply referred to as “joint mechanisms 410 to 470”. Similarly, in some cases, the first shoulder joint mechanism 510, the second shoulder joint mechanism 520, the upper arm twist mechanism 530, the elbow joint mechanism 540, the front arm twist mechanism 550, the wrist joint mechanism 560, and the wrist twist mechanism 570 of the second articulated arm 240 are simply referred to as “joint mechanisms 510 to 570”.

In the first articulated arm 230, the appearance thereof is different from the appearance of the second articulated arm 240. Specifically, in order to attract human (worker) attention to the first articulated arm 230, yellow and black stripes or red and blue stripes are drawn on an outer surface of the first articulated arm 230, thereby varying a surface pattern of the arm. A difference in the appearance between the first articulated arm 230 and the second articulated arm 240 will be described later.

FIG. 2 is an explanatory view for illustrating the end effectors 610 and 620 to be attached to the articulated arms 230 and 240 of the robot 100. The end effectors 610 and 620 are portions corresponding to human hands, and have a function of gripping an object, for example. A configuration of the end effectors 610 and 620 varies depending on work to be carried out. However, for example, a configuration having first fingers 611 and 621 and second fingers 612 and 622 can be adopted. The end effectors 610 and 620 configured as described above can grip the object by adjusting a separated distance between the first fingers 611 and 621 and the second fingers 612 and 622. In addition, the end effectors 610 and 620 can be operated in the directions (three-dimensions) of the three axes which are orthogonal to one another, in accordance with an operation of the articulated arms 230 and 240 to which the end effectors 610 and 620 are attached.

The force sensors 740 and 750 are attached to portions between the connection portions 237 and 247 and the end effectors 610 and 620. The force sensors 740 and 750 have a function of detecting an external force applied to the end effectors 610 and 620. Then, the robot 100 can more accurately carry out work by feeding back the force detected by the force sensors 740 and 750 to the robot control device 900. In addition, it is possible to detect whether the end effectors 610 and 620 are in contact with an obstacle, by using the force or moment detected by the force sensors 740 and 750. Therefore, it is possible to easily perform an obstacle avoiding operation or an object damage avoiding operation. If force components and moment components can be detected in the three axes which are orthogonal to one another, a known force sensor can be used as the force sensors 740 and 750 without being particularly limited.

The robot control device 900 operates the waist joint mechanism 310 of the trunk 220, the joint mechanisms 410 to 470 of the first articulated arm 230, and the joint mechanisms 510 to 570 of the second articulated arm 240, respectively and independently. In this manner, the first articulated arm 230 and the second articulated arm 240 can be operated in the directions (three-dimensions) of the three axes (x, y, and z) which are orthogonal to one another. A configuration of the robot control device 900 will be described later.

### B2. Operation State of Robot

The robot 100 having the above-described configuration is used in assembling a product through joint work between a worker (human being) 1000 and another robot, in some cases. Hereinafter, an operation state of the robot 100 will be described by selecting a case of the joint work as an example.

### 1. Case of Joint Work Between Robot and Worker

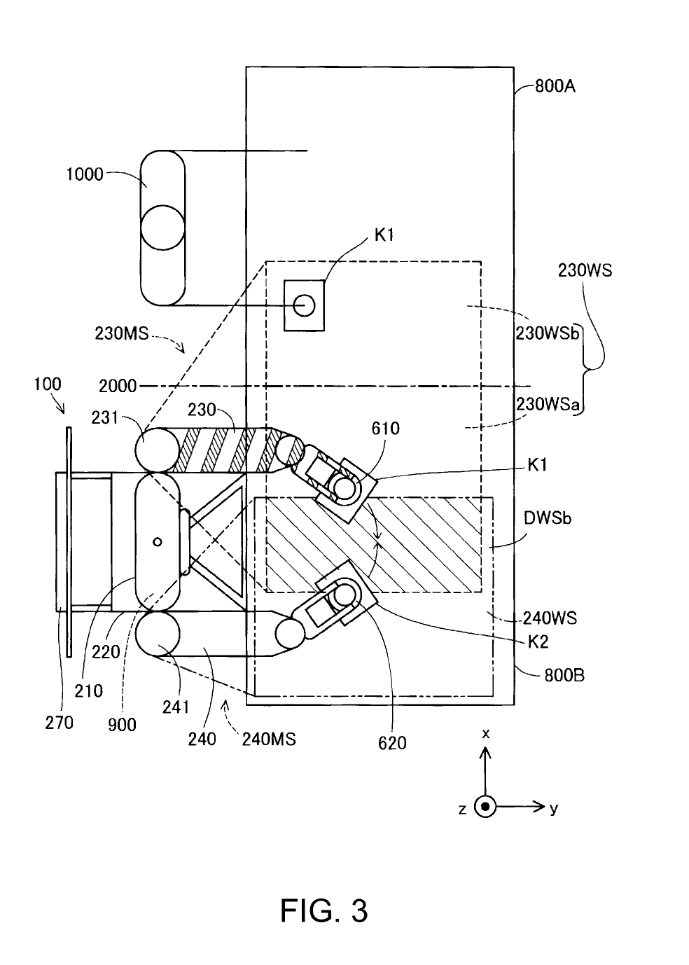

FIG. 3 is an explanatory view illustrating a work area of the robot in the joint work when the worker is arranged beside the robot. A first work table 800A and a second work table 800B have a rectangular shape which is long in an x-axis direction when viewed from the positive side of the z-axis, and are juxtaposed along the x-axis direction. The worker 1000 is arranged in front of (on the left side in FIG. 3) of the first work table 800A, and the robot 100 is arranged in front of (on the left side in the drawing) of the second work table 800B. The worker 1000 and the robot 100 are arranged side by side and adjacent to each other along the x-axis direction so as to face the same direction (on the positive side in the y-axis direction). The worker 1000 carries out work on the first work table 800A, and the robot 100 carries out work on the second work table 800B. In this manner, the worker 1000 and the robot 100 carry out joint work side by side so as to face the same direction. For example, a case is illustrated as an example in which the worker 1000 produces a first workpiece K1 on the first work table 800A, the adjacent robot 100 beside the worker 1000 carries out assembling work of the first workpiece K1 and a second workpiece K2 on the second work table 800B after receiving the first workpiece K1 on the first work table 800A.

In the robot 100, a left arm located on a proximal side of the worker 1000 is the first articulated arm 230, and a right arm located on a distal side of the worker 1000 is the second articulated arm 240. As described above, the first articulated arm 230 is set to be operable in the directions (three-dimensions) of the three axes which are orthogonal to one another within a range (area of a pentagonal frame illustrated by a two-dot chain line) of a first arm movable area (operation area) 230MS by moving the joint mechanisms 410 to 470 (refer to FIG. 1) respectively and independently. The second articulated arm 240 is also set to be operable within a range (area of a pentagonal frame illustrated by a two-dot chain line) of a second arm movable area (operation area) 240MS by moving the joint mechanisms 510 to 570 (refer to FIG. 1) respectively and independently.

The first arm movable area 230MS is an area extending from the vicinity of the center in the longitudinal direction of the second work table 800B to an area on the second work table 800B side by exceeding a boundary line 2000 (line parallel to the y-axis) between the first work table 800A and the second worktable 800B. In contrast, the second arm movable area 240MS is an area extending from the vicinity of the center in the longitudinal direction (x-axis direction) of the second work table 800B to an end portion side opposite to the boundary line 2000 without exceeding the boundary line 2000. A difference between the first arm movable area 230MS and the second arm movable area 240MS means that the sizes thereof are different from each other in order to carry out at least one job.

The second end effector 620 of the second articulated arm 240 can carry out work in a work area 240WS. Within the second arm movable area 240MS, this work area 240WS is set to be an area illustrated by a rectangular frame of a two-dot chain line, which extends from an end portion (lower end portion in the drawing) side opposite to the boundary line 2000 on the second work table 800B to the vicinity of the center in the longitudinal direction of the second work table 800B. This work area 240WS is referred to as a “second arm work area 240WS”.

The first end effector 610 of the first articulated arm 230 can carry out work in a work area 230WS. Within the first arm movable area 230MS, this work area 230WS is set to be an area illustrated by a rectangular frame of a dashed line, which extends from the vicinity of the center on the second work table 800B overlapping the second arm work area 240WS through a partial area on the first work table 800A across the boundary line 2000. This work area 230WS is referred to as a “first arm work area 230WS”.

The first arm work area 230WS includes a first work area portion 230WSa (area illustrated by a rectangular frame of a dashed line in the drawing) which is substantially symmetrical to the second arm work area 240WS on the second work table 800B, and a second work area portion 230WSb (area illustrated by a rectangular frame of a dashed line in the drawing) on the first work table 800A. Therefore, the first arm work area 230WS is larger than the second arm work area 240WS by an amount of the second work area portion 230WSb, and the first arm movable area 230MS is larger than the second arm movable area 240MS. However, the first work area portion 230WSa and the second work area portion 230WSb which are illustrated in FIG. 3 are illustrated by reducing the sizes in the y-axis direction in order to facilitate understanding of the drawing.

The first work area portion 230WSa of the first arm work area 230WS and the second arm work area 240WS of the second articulated arm 240 include an area DWSb (area having rightward and downward hatching in the drawing) where both of these overlap each other. This area DWSb is referred to as a “cooperation work area DWSb”. The robot 100 can carry out various work tasks such as assembling work of workpieces by causing the first end effector 610 of the first articulated arm 230 and the second end effector 620 of the second articulated arm 240 to cooperate with each other in the cooperation work area DWSb.

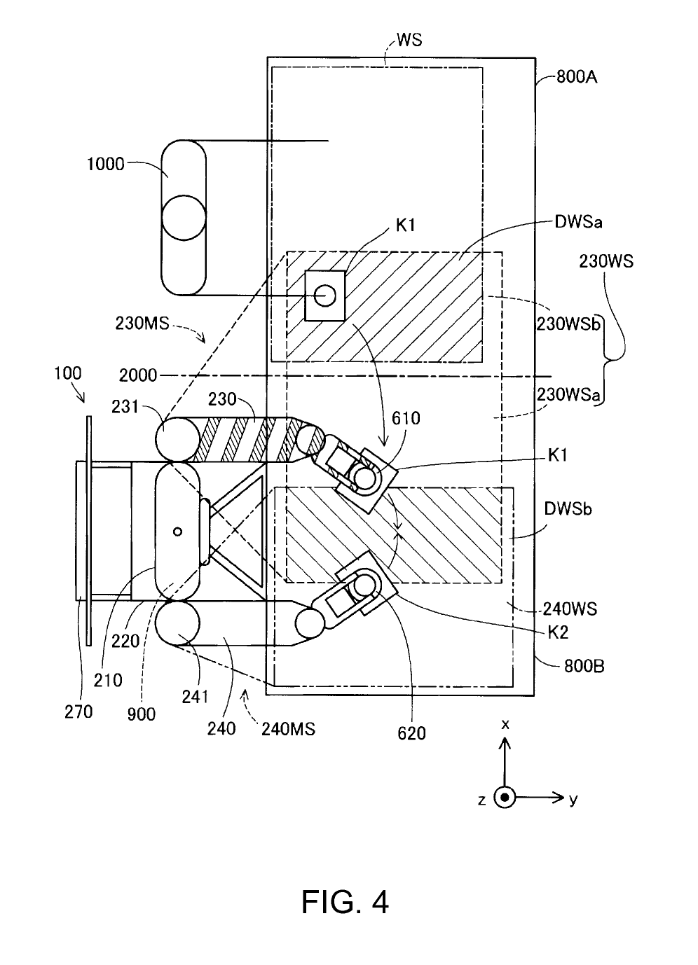

FIG. 4 is an explanatory view for illustrating a work area of the worker in addition to the work area of the robot illustrated in FIG. 3. The worker 1000 can carry out various work tasks such as assembling work of workpieces in an area WS illustrated by a rectangular frame of a one-dot chain line on the first work table 800A. This area WS is referred to as a “worker work area WS”.

The second work area portion 230WSb included in the first arm work area 230WS of the robot 100 includes an area DWSa (area having rightward and upward hatching in the drawing) which overlaps the worker work area WS. This area DWSa is referred to as a “joint work area DWSa”. The robot 100 can jointly carry out various work tasks such as delivery of workpieces in the joint work area DWSa.

As described above, the worker 1000 and the robot 100 can jointly carry out work. For example, the worker 1000 produces the first workpiece K1 in the worker work area WS, and arranges the first workpiece K1 in the joint work area DWSa. The robot 100 causes the first end effector 610 of the first articulated arm 230 to grip the first workpiece K1 arranged in the joint work area DWSa, and moves the first workpiece K1 to the cooperation work area DWSb of the first arm work area 230WS (specifically, the first work area portion 230WSa). In addition, the robot 100 causes the second end effector 620 of the second articulated arm 240 to grip the second workpiece K2 arranged in a member arrangement portion (not illustrated), and moves the second workpiece K2 to the cooperation work area DWSb. Then, the robot 100 can assemble the first workpiece K1 and the second workpiece K2 by causing the first end effector 610 of the first articulated arm 230 and the second end effector 620 of the second articulated arm 240 to cooperate with each other.

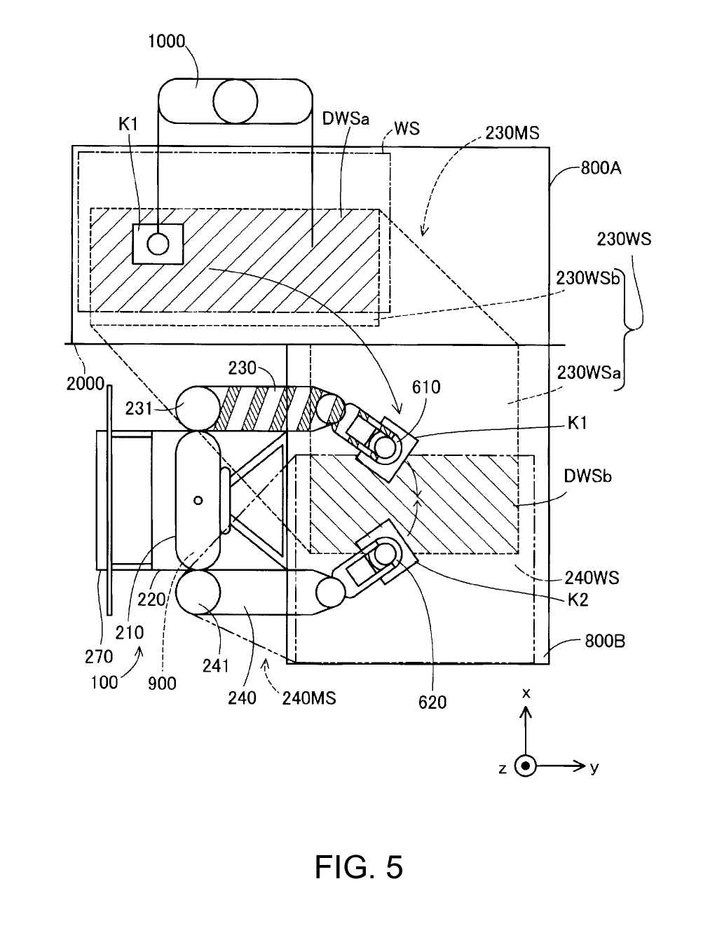

FIG. 5 is an explanatory view for illustrating another example of the work area of the robot for joint work when the worker is arranged beside the robot. This example is different from the examples illustrated in FIGS. 3 and 4 in that the first work table 800A is in a state rotated toward the second work table 800B by 90 degrees, that is, the longitudinal direction of the first work table 800A is installed to be oriented along the y-axis direction, and the worker 1000 is located beside the robot 100, but is arranged so as to face a direction toward the robot 100 (negative side in the x-axis direction) across the first work table 800A. In addition, due to a difference in these arrangements, a shape of the first arm movable area 230MS of the first articulated arm 230 of the robot 100 located on the proximal side of the worker 1000, a shape of the first arm work area 230WS, a shape of the second work area portion 230WSb on the first work table 800A which is included in the first arm work area 230WS, and a shape of the joint work area DWSa are different from those in the examples illustrated in FIGS. 3 and 4. However, the roles in the respective areas are the same as those in the examples illustrated in FIGS. 3 and 4.

In the examples illustrated in FIGS. 3 and 4, and FIG. 5, when the worker 1000 and the robot 100 jointly carry out work, there is a possibility that the first articulated arm 230 of the robot 100 may interfere with the work of the worker 1000 particularly in the joint work area DWSa. For example, the first articulated arm 230 may approach the worker 1000, and may further come into contact with the worker 1000. Therefore, it is desirable to sufficiently ensure safety of the worker 1000. in addition, the worker 1000 needs to carry out the work while paying attention to approach of the first articulated arm 230 and further being cautious about avoiding contact. Consequently, the worker 1000 cannot sufficiently concentrate on the work, thereby causing a possibility that smooth work may not be carried out. In contrast, in the robot 100, the first articulated arm 230 which is likely to interfere with the worker 1000 has an appearance different from that of the second articulated arm 240. Accordingly, the difference in the appearance of the arms enables the worker 1000 to easily recognize the presence of the first articulated arm 230, and to easily predict the approach and contact of the first articulated arm 230. As a result, the safety of the worker 1000 is improved. In addition, since the first articulated arm 230 can be more easily recognized, the worker 1000 can concentrate further on the work while concentrating less on the first articulated arm 230. In this manner, it is possible to carry out further improved smooth work.

In the examples illustrated in FIGS. 3 and 4, and FIG. 5, the worker 1000 is arranged on the left side of the robot 100. Therefore, a case has been described as an example where the left arm of the robot 100 is the first articulated arm 230 and the right arm is the second articulated arm 240. However, in a case where the worker 1000 is arranged on the right side of the robot 100, the right arm may be the first articulated arm 230 and the left arm may be the second articulated arm 240.

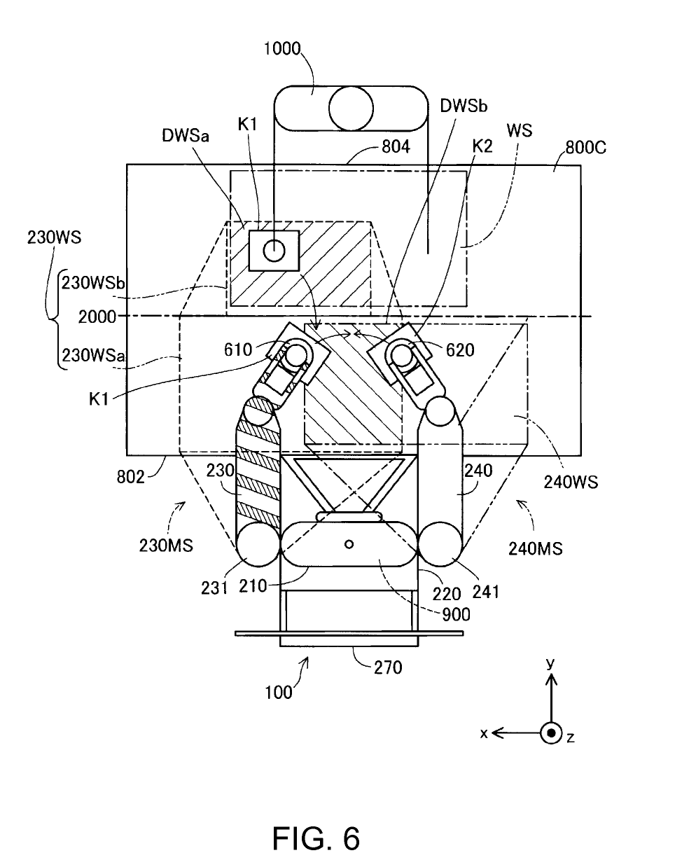

FIG. 6 is an explanatory view for illustrating an example of the work area of the robot for joint work when the worker is arranged to oppose the robot in front of the robot. The robot 100 is arranged to face the positive side in the y-axis direction in front of a one edge 802 of a work table 800C disposed along the x-axis direction, and the worker 1000 is arranged to face the negative side in the y-axis direction in front of another edge 804 of the work table 800C which opposes the one edge 802. That is, this example illustrates a case where the robot 100 and the worker 1000 are arranged so as to oppose each other across the work table 800C along the y-axis direction, and carry out the joint work while opposing each other.

The worker work area WS where the worker 1000 carries out the work is set to be an area (area of a rectangular frame illustrated by a one dot chain line) between a boundary line 2000 extending along the x-axis direction in the middle of the two opposing edges 802 and 804 of the work table 800C and the edge 804 on the worker 1000 side. As described above, the worker 1000 carries out the work in the worker work area WS. For example, the worker 1000 assembles the first workpiece K1.

The second articulated arm 240 serving as the right arm of the robot 100 is set to be operable in the second arm movable area 240MS (area of a pentagonal frame illustrated by a two-dot chain line) on the negative side in the y-axis direction from the boundary line 2000. Similarly to a case of the lateral arrangement illustrated in FIGS. 3 and 4, and FIG. 5, the second arm work area 240WS (area of a rectangular frame illustrated by a two-dot chain line) where the second end effector 620 of the second articulated arm 240 can carry out work is set to be located in the second arm movable area 240MS. The second arm work area 240WS is an area between the boundary line 2000 and the edge 802 of the work table 800C, and is an area on the negative side (right side in the drawing) in the x-axis direction from the vicinity of the center of the work table 800C.

In contrast, the first articulated arm 230 serving as the left arm of the robot 100 is set to be operable in the first arm movable area 230MS (area of polygonal frame illustrated by a dashed line) including an area extending to a portion of the worker work area WS on the positive side in the y-axis direction from the boundary line 2000, in addition to an area symmetrical to the second arm movable area 240MS of the second articulated arm 240 serving as the right arm. Similarly to a case of the lateral arrangement illustrated in FIGS. 3 and 4, the first arm work area 230WS where the first end effector 610 of the first articulated arm 230 can carry out work is set to be located in the first arm movable area 230MS. The first arm work area 230WS includes the first work area portion 230WSa (portion illustrated by a rectangular frame of a dashed line) on the robot 100 side across the boundary line 2000, and the second work area portion 230WSb (portion illustrated by a rectangular frame of a dashed line) on the worker 1000 side. The first work area portion 230WSa is an area which is substantially symmetrical to the second arm work area 240WS. Similarly to a case of the lateral arrangement illustrated in FIGS. 3 and 4, and FIG. 5, in this example, the first arm movable area 230MS is also larger than the second arm movable area 240MS, and the first arm work area 230WS is also larger than the second arm work area 240WS. In this example, the second work area portion 240WS is also illustrated by further reducing the size in the y-axis direction as compared to the size of the first arm work area 230WSa in the y-axis direction in order to facilitate understanding of the drawing.

An overlapping area (area having rightward and downward hatching) between the first work area portion 230WSa of the first arm work area 230WS and the second arm work area 240WS is the cooperation work area DWSb of the robot 100. In addition, an overlapping area (area having rightward and upward hatching) between the second work area portion 230WSb of the first arm work area 230WS and the worker work area WS is the joint work area DWSa of the worker 1000 and the robot 100.

Similarly to a case of the lateral arrangement illustrated in FIGS. 3 and 4, and FIG. 5, in this example, the worker 1000 and the robot 100 can also jointly carry out various work tasks such as delivery of workpieces in the joint work area DWSa where the worker work area WS and the first arm work area 230WS (specifically, the second work area portion 230WSb). Then the robot 100 can carry out various work tasks such as assembling work of workpieces by causing the first articulated arm 230 and the second articulated arm 240 to cooperate with each other in the cooperation work area DWSb where the first arm work area 230WS (specifically, the first work area portion 230WSa) and the second arm work area 240WS. In this manner, the worker 1000 and the robot 100 can jointly carry out work.

In this example, a difference in the appearance of the arms also enables the worker 1000 opposing the robot 100 to easily recognize the presence of the first articulated arm 230, and to easily predict the approach and contact of the first articulated arm 230. As a result, the safety of the worker 1000 is improved. In addition, since the first articulated arm 230 can be more easily recognized, the worker 1000 can concentrate further on the work while concentrating less on the first articulated arm 230. In this manner, it is possible to carry out further improved smooth work.

In this example, a case has been described as an example where the left arm is the first articulated arm 230 and the right arm is the second articulated arm 240. However, the right arm may be the first articulated arm 230 and the left arm may be the second articulated arm 240.

Hitherto, in the examples illustrated in FIGS. 3 to 6, components required for work or arrangement places for tools are omitted in order to facilitate the description. However, in practice, the arrangement places are included in the first arm work area 230WS within the first arm movable area 230MS of the first articulated arm 230, or the second arm work area 240WS of the second articulated arm 240.

A case has been described as an example where the work tables 800A, 800B, and 800C are rectangular work tables, but is not limited thereto. For example, one work table having a shape in which the two work tables 800A and 800B are integrated with each other may be divided into two. Alternatively, the work table may have various polygonal shapes including a dedicated arrangement area for the above-described components or tools.

Depending on the presence of the arrangement place for the components or the tools required for work, a shape of the work table, and positions of the robot and the worker, respective sizes or respective shapes may be appropriately changed for the first arm movable area 230MS, the second arm movable area 240MS, the first arm work area 230WS, the second arm work area 240WS, the worker work area WS, the joint work area DWSa, and the cooperation work area DWSb.

### 2. Case of Joint Work Between Robot and Another Robot

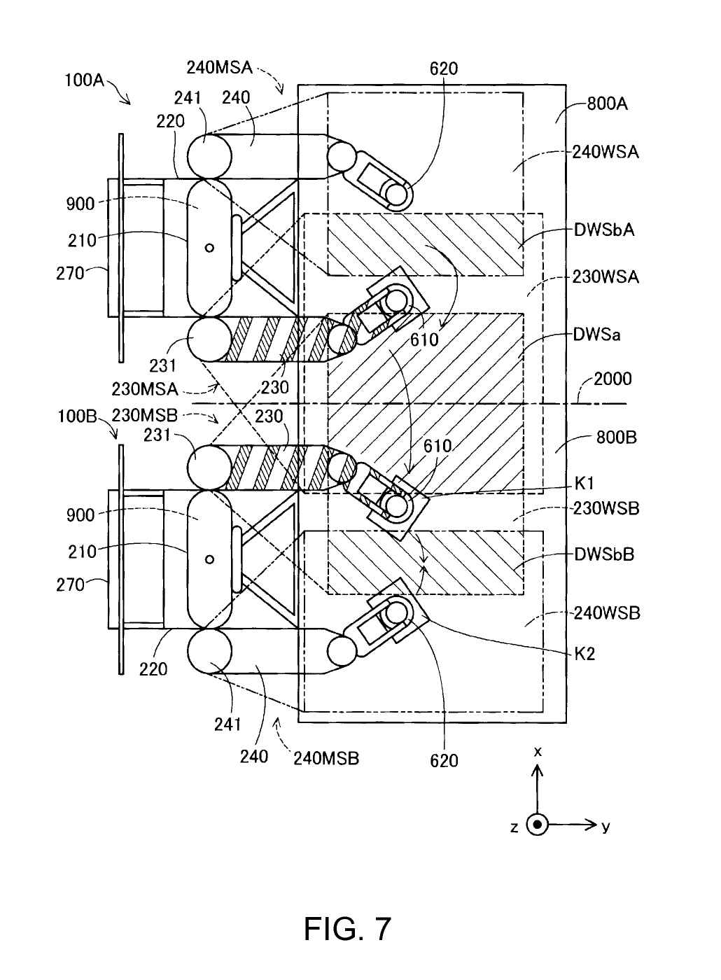

FIG. 7 is an explanatory view for illustrating an example of the work area of the robot when another robot is arranged instead of the worker 1000 in FIG. 3. As illustrated in FIG. 7, a first robot 100A is arranged in front (on the left side in the drawing) of the first work table 800A instead of the worker 1000 in FIG. 3, and a second robot 100B is arranged in front (on the left side in the drawing) of the second work table 800B. The first robot 100A and the second robot 100B are arranged side by side and adjacent to each other so as to face the same direction (positive side in the y-axis direction) along the x-axis direction. Similarly to the robot 100 in FIG. 3, the second robot 100B is configured so that the left arm is the first articulated arm 230 and the right arm is the second articulated arm 240.

Similarly to the robot 100 in FIG. 3, the second robot 100B is configured so that the first articulated arm 230 serving as the left arm is operable within a range (area of a pentagonal frame illustrated by a dashed line) of a first arm movable area 230MSB, and can carry out work in a first arm work area 230WSB (portion illustrated by a rectangular frame of a dashed line in the drawing) across the boundary line 2000. In addition, the second articulated arm 240 serving as the right arm is also operable within a range (area of a pentagonal frame illustrated by a two-dot chain line) of a second arm movable area 240MSB, and can carry out work in a second arm work area 240WSB (portion illustrated by a rectangular frame of a two-dot chain line in the drawing).

The second robot 100B causes the first articulated arm 230 and the second articulated arm 240 to be operated in cooperation with each other in a cooperation work area DWSbA (area having rightward and downward hatching in the drawing) which is an area where the first arm work area 230WSB and the second arm work area 240WSB overlap each other. For example, in this manner, the second robot 100B can carry out various work tasks such as assembling work of workpieces.

The first robot 100A is configured so that the right arm on the proximal side of the second robot 100B is the first articulated arm 230 and the left arm on the distal side is the second articulated arm 240. The first robot 100A and the second robot 100B are the same as each other except that the articulated arms configuring the arms are laterally opposite to each other. In the first robot 100A, the first arm movable area and the first arm work area of the first articulated arm 230 are referred to as a “first arm movable area 230MSA” and a “first arm work area 230WSA”, and the second arm movable area and the second arm work area of the second articulated arm 240 are referred to as a “second arm movable area 240MSA” and a “second arm work area 240WSA”.

The first arm work area 230WSA of the first articulated arm 230 serving as the right arm of the first robot 100A and the first arm work area 230WSB of the first articulated arm 230 serving as the left arm of the second robot 100B have a joint work area DWSa (area having rightward and upward hatching in the drawing) which is an overlapping area across the boundary line 2000. The first robot 100A and the second robot 100B can carry out various work tasks such as delivery of workpieces, for example, by respectively using the first articulated arms 230 in the joint work area DWSa.

In this example, for example, the first robot 100A can produce the first workpiece K1 instead of the worker 1000, and can arrange the first workpiece K1 in the joint work area DWSa. At this time, similarly to the robot 100 in FIG. 3, the second robot 100B causes the first end effector 610 of the first articulated arm 230 to grip the first workpiece K1 arranged in the joint work area DWSa, and moves the first workpiece K1 to a cooperation work area DWSbA. In addition, the second robot 100B causes the second end effector 620 of the second articulated arm 240 to grip the second workpiece K2 arranged in a member arrangement portion (not illustrated), and moves the second workpiece K2 to the cooperation work area DWSbA. Then, the second robot 100B can assemble the first workpiece K1 and the second workpiece K2 by causing the first articulated arm 230 and the first end effector 610, and the second articulated arm 240 and the second end effector 620 to cooperate with each other.

In this example, the robots 100A and 100B are configured so that the respective first articulated arms 230 having a different appearance can be more easily recognized by being monitored using the above-described stereo camera 250. Accordingly, it becomes easy to predict the approach or contact of the respective first articulated arms 230, and it becomes easy to avoid contact. Therefore, it is possible to improve safety in the work, and it is possible to achieve further improved smooth work.

The example in FIG. 7 illustrates a case where the robot 100 in FIG. 3 serves as the second robot 100B and the worker 1000 is replaced with the first robot 100A. However, the robot 100 in FIGS. 5 and 6 can also serve as the second robot 100B and the worker 1000 can also be replaced with the first robot 100A. In addition, the robot replacing the worker 1000 may employ other various types of the robot, without being limited to the second robot 100B, that is, the robot 100 in FIG. 1.

### B3. Operation Control of Robot

An operation state of the above-described robot 100 (100A and 100B) is controlled by the robot control device 900 driving the waist joint mechanism 310 of the trunk 220, the respective joint mechanisms 410 to 470 of the first articulated arm 230, and the respective joint mechanisms 510 to 570 for the joints of the second articulated arm 240, respectively.

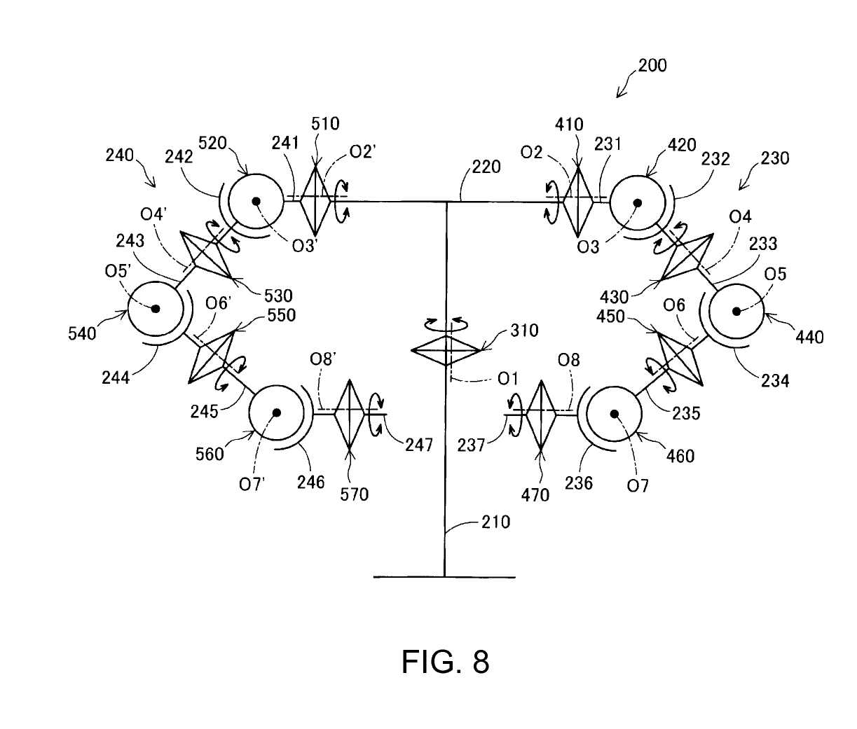

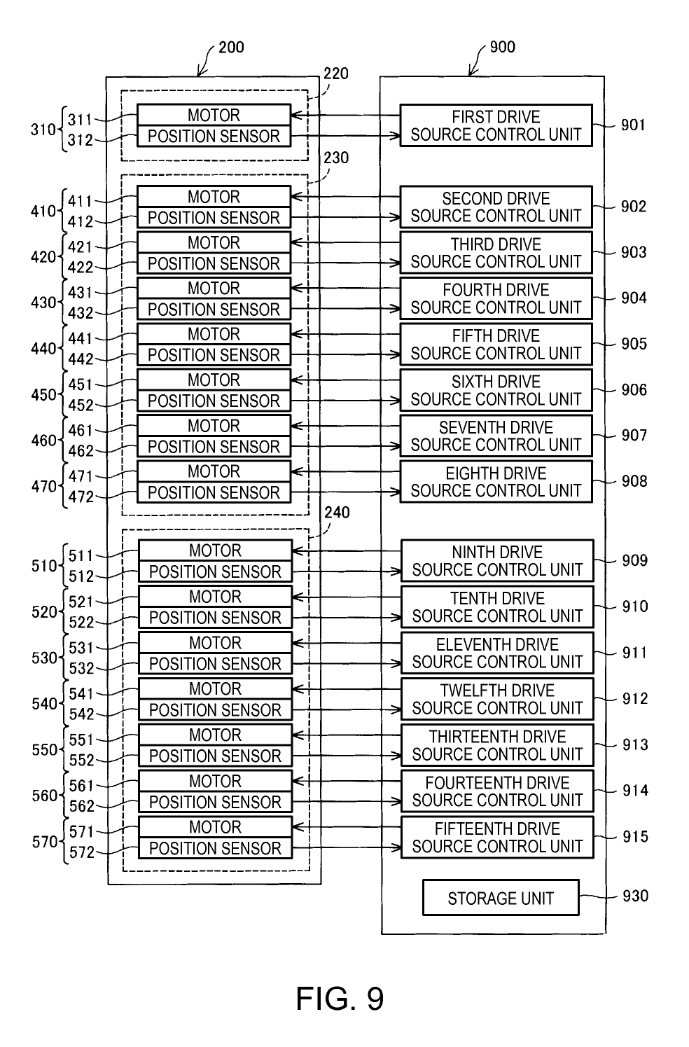

FIG. 8 is a schematic configuration diagram illustrating a joint mechanism and a rotary shaft of the robot 100. FIG. 9 is a block diagram illustrating a control system of the robot 100.

As illustrated in FIG. 8, the trunk 220 of the robot main body 200 is connected to the base 210 so as to be rotatable around a rotary shaft O1 via the waist joint mechanism 310. A configuration of the waist joint mechanism 310 is not particularly limited as long as the trunk 220 is rotatable around the rotary shaft O1 with respect to the base 210. However, as illustrated in FIG. 8, a configuration is adopted which has a motor 311 serving as a drive source, a speed reducer (not illustrated) which reduces rotation speed of the motor 311, and a position sensor 312 which detects a rotation angle of the motor 311. For example, as the motor 311, it is possible to use servo motors such as an AC servo motor and a DC servo motor. For example, as the speed reducer, it is possible to use a planetary gear-type speed reducer and a Harmonic Drive (“Harmonic Drive” is a registered trademark). For example, as the position sensor 312, it is possible to use a linear encoder, a rotary encoder, a resolver, and a potentiometer.

As illustrated in FIG. 8, in the first articulated arm 230, the first shoulder joint mechanism 410 rotates the first shoulder 231 around a rotary shaft O2 orthogonal to the rotary shaft O1 with respect to the trunk 220, and the second shoulder joint mechanism 420 rotates the second shoulder 232 around a rotary shaft O3 orthogonal to the rotary shaft O2 with respect to the first shoulder 231. The upper arm twist mechanism 430 rotates (twists) the upper arm 233 around a rotary shaft O4 orthogonal to the rotary shaft O3 with respect to the second shoulder 232. The elbow joint mechanism 440 rotates the first front arm 234 around a rotary shaft O5 orthogonal to the rotary shaft O4 with respect to the upper arm 233, and the front arm twist mechanism 450 rotates (twists) the second front arm 235 around a rotary shaft O6 orthogonal to the rotary shaft O5 with respect to the first front arm 234. The wrist joint mechanism 460 rotates the wrist 236 around a rotary shaft O7 orthogonal to the rotary shaft O6 with respect to the second front arm 235, and the wrist twist mechanism 470 rotates (twists) the first end effector 610 connected to the connection portion 237 around a rotary shaft O8 orthogonal to the rotary shaft O7 with respect to the wrist 236.

As illustrated in FIG. 8, the first shoulder joint mechanism 510, the second shoulder joint mechanism 520, the upper arm twist mechanism 530, the elbow joint mechanism 540, the front arm twist mechanism 550, the wrist joint mechanism 560, and the wrist twist mechanism 570 of the second articulated arm 240 are the same as the respective corresponding joint mechanisms 410 to 470 of the first articulated arm 230. However, a rotary shaft of the first shoulder joint mechanism 510 is a rotary shaft O2′ orthogonal to the rotary shaft O1, and a rotary shaft of the second shoulder joint mechanism 520 is a rotary shaft O3′ orthogonal to the rotary shaft O2′. A rotary shaft of the upper arm twist mechanism 530 is a rotary shaft O4′ orthogonal to the rotary shaft O3′, and a rotary shaft of the elbow joint mechanism 540 is a rotary shaft O5′ orthogonal to the rotary shaft O4′. A rotary shaft of the front arm twist mechanism 550 is a rotary shaft O6′ orthogonal to the rotary shaft O5′. A rotary shaft of the wrist joint mechanism 560 is a rotary shaft O7′ orthogonal to the rotary shaft O6′, and a rotary shaft of the wrist twist mechanism 570 is a rotary shaft O8′ orthogonal to the rotary shaft O7′.

Each configuration of the respective joint mechanisms 410 to 470 in the first articulated arm 230 and each configuration of the respective joint mechanisms 510 to 570 in the second articulated arm 240 are not particularly limited. However, this embodiment adopts a configuration which is the same as that of the above-described waist joint mechanism 310. That is, as illustrated in FIG. 9, as a first drive mechanism for driving the first articulated arm 230, the first articulated arm 230 has respective motors 411 to 471 serving as drive sources respectively corresponding to the respective joint mechanisms 410 to 470, a speed reducer (not illustrated) for reducing rotation speed of the respective motors 411 to 471, and position sensors 412 to 472 for detecting a rotation angle of the respective motors 411 to 471. In addition, as a second drive mechanism for driving the second articulated arm 240, the second articulated arm 240 has respective motors 511 to 571 serving as drive sources respectively corresponding to the respective joint mechanisms 510 to 570, a speed reducer (not illustrated) for reducing rotation speed of the respective motors 511 to 571, and position sensors 512 to 572 for detecting a rotation angle of the respective motors 511 to 571.

These articulated arms 230 and 240 can be operated in three directions (three-dimensions) of the x-axis direction, the y-axis direction, and the z-axis direction. Therefore, according to these articulated arms 230 and 240, a relatively simple configuration enables joints (shoulder, elbow, and wrist) to be bent and extended similarly to human arms, and enables the upper arm and the front arm to be practically twisted.

As illustrated in FIG. 9, the robot control device 900 has a storage unit 930, and can operate the trunk 220, and the articulated arms 230 and 240, respectively and independently. The storage unit 930 has a storage medium (also referred to as a recording medium) for storing (also referred to as recording) various information items, data items, tables, calculation expressions, and programs. For example, the storage medium is configured to include a volatile memory such as a RAM, a non-volatile memory such as a ROM, rewritable (erasable and rewritable) and non-volatile memories such as an EPROM, an EEPROM, and a flash memory, various semiconductor memories, and an IC memory.

Via a motor driver (not illustrated), the robot control device 900 can control the drive of the motor 311 included in the waist joint mechanism 310, the motors (also referred to as first drive motors) 411 to 471 included in the respective joint mechanisms 410 to 470 of the first articulated arm 230, and the motors 511 to 571 (also referred to as second drive motors) included in the respective joint mechanisms 510 to 570 of the second articulated arm 240, independently.

In this case, the robot control device 900 causes the position sensors 312, 412 to 472, and 512 to 572 to detect angular speed or a rotation angle of the respective motors 311, 411 to 471, and 511 to 571. Based on a detection result thereof, the robot control device 900 controls the drive of the respective motors 311, 411 to 471, and 511 to 571. This control program is stored in advance in a recording medium (not illustrated) incorporated in the robot control device 900. This control program is executed, thereby causing the robot control device 900 to be operated as drive source control units 901 to 915 which control the drive of the respective motors 311, 411 to 471, and 511 to 571.

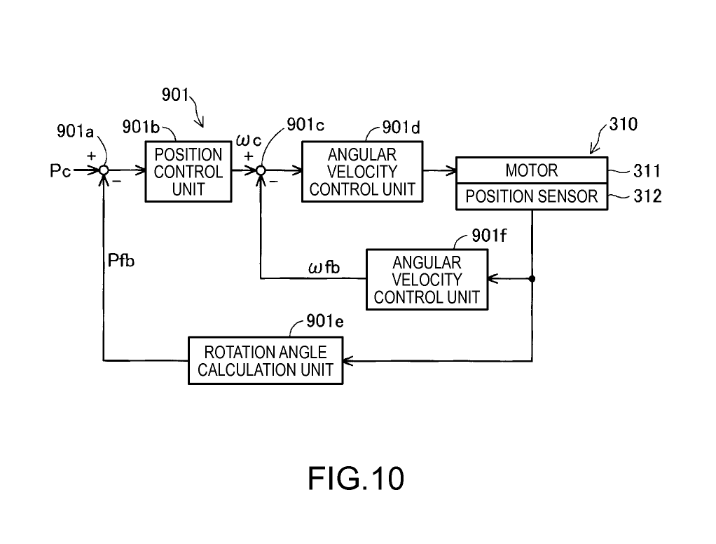

FIG. 10 is a block diagram illustrating the first drive source control unit 901 within the robot control device 900 which performs drive control for the robot 100. The first drive source control unit 901 has a subtractor 901a, a position control unit 901b, a subtractor 901c, an angular speed control unit 901d, a rotation angle calculation unit 901e, and an angular speed calculation unit 901f. Then, a detection signal in addition to a position command Pc of the motor 311 (refer to FIG. 8) of the waist joint mechanism 310 is input from the position sensor 312 to the first drive source control unit 901. The first drive source control unit 901 drives the motor 311 through feedback control using each detection signal so that a rotation angle (position feedback value Pfb) of the motor 311 which is calculated from the detection signal of the position sensor 312 becomes the position command Pc and an angular speed feedback value ω̅fb (to be described later) becomes an angular speed command ω̅c (to be described later). That is, the position command Pc is input to the subtractor 901a, and the position feedback value Pfb (to be described later) is input from the rotation angle calculation unit 901e to the subtractor 901a. The number of pulses input from the position sensor 312 is counted by the rotation angle calculation unit 901e, and a rotation angle of the motor 311 according to a counted value thereof is output to the subtractor 901a as the position feedback value Pfb. The subtractor 901a outputs a deviation (value obtained by subtracting the position feedback value Pfb from a target value of the rotation angle of the motor 311) between the position command Pc and the position feedback value Pfb to the position control unit 901b.

The position control unit 901b performs a predetermined calculation process by using a deviation input from the subtractor 901a and a proportional gain which is a predetermined coefficient, thereby calculating a target value of the angular speed of the motor 311 according to the deviation. The position control unit 901b outputs a signal indicating the target value (command value) of the angular speed of the motor 311 to the subtractor 901c as the angular speed command ω̅c.

The angular speed calculation unit 901f calculates the angular speed of the motor 311, based on the frequency of the pulse signal input from the position sensor 312. The angular speed is output to the subtractor 901c as the angular speed feedback value ω̅fb.

The angular speed command ω̅c and the angular speed feedback value ω̅fb are input to the subtractor 901c. The subtractor 901c outputs a deviation (value obtained by subtracting the angular speed feedback value ω̅fb from a target value of the angular speed of the motor 311) between the angular speed command ω̅c and the angular speed feedback value ω̅fb to the angular speed control unit 901d.

The angular speed control unit 901d performs a predetermined calculation process including integration by using the deviation input from the subtractor 901c and a proportional gain which is a predetermined coefficient, thereby generating a drive signal of the motor 311 according to the deviation, and supplying the drive signal to the motor 311 via the motor driver. In this manner, the angular speed control unit 901d performs feedback control so that the position feedback value Pfb becomes equal to the position command Pc as much as possible and the angular speed feedback value ω̅fb becomes equal to the angular speed command ω̅c as much as possible. The drive of the motor 311 is controlled, that is, the rotation of the trunk 220 is controlled.

The second to fifteenth drive source control units 902 to 915 are also respectively the same as the first drive source control unit 901. Therefore, the second to eighth drive source control units 902 to 908 control the rotation of the respective joint mechanisms 410 to 470 of the first articulated arm 230, and the ninth to fifteenth drive source control units 909 to 915 control the rotation of the respective joint mechanisms 510 to 570 of the second articulated arm 240.

As described above, the robot control device 900 controls the rotation of the waist joint mechanism 310 of the trunk 220, the rotation of the respective joint mechanisms 410 to 470 of the first articulated arm 230, and the rotation of the respective joint mechanisms 510 to 570 of the second articulated arm 240. In this manner, the robot control device 900 can cause the first articulated arm 230 to be operated in the first arm movable area 230MS and the first arm work area 230WS which are described above, and can cause the second articulated arm 240 to be operated in the second arm movable area 240MS and the second arm work area 240WS which are described above.

### C. Second Embodiment

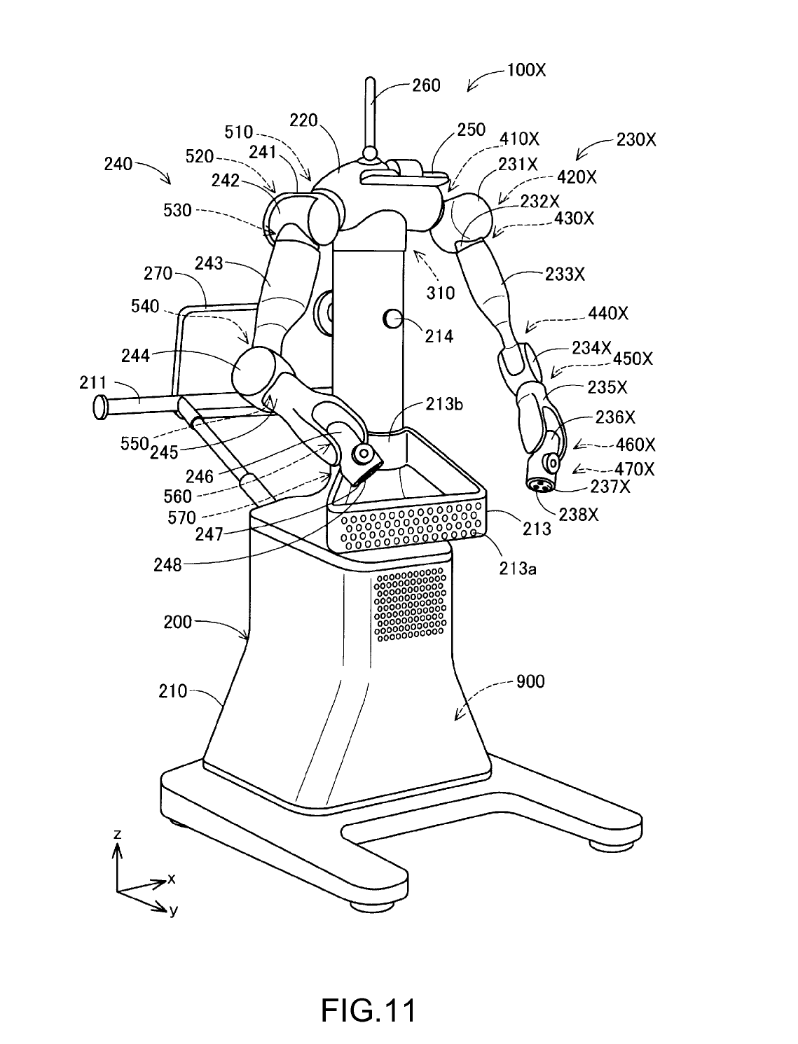

FIG. 11 is a perspective view illustrating a robot 100X according to a second embodiment of the invention. The robot 100X is the same as the robot 100 according to the first embodiment except that the first articulated arm 230 serving as the left arm of the robot 100 (refer to FIG. 1) according to the first embodiment is changed to a first articulated arm 230X.

Similarly to the first articulated arm 230, the first articulated arm 230X has a first shoulder joint mechanism 410X, a first shoulder 231X, a second shoulder joint mechanism 420X, a second shoulder 232X, an upper arm twist mechanism 430X, an upper arm 233X, an elbow joint mechanism 440X, a first front arm 234X, a front arm twist mechanism 450X, a second front arm 235X, a wrist joint mechanism 460X, a wrist 236X, a wrist twist mechanism 470X, and a connection portion 237X which are connected sequentially from the trunk 220. Then, the connection portion 237X has an end effector attachment portion 238X. As illustrated in FIG. 2, the first end effector 610 according to work to be carried out by the robot 100X is attached to the end effector attachment portion 238X via the force sensor 740.

The first articulated arm 230X has a structure which is different from that of the second articulated arm 240. Specifically, in order to attract human attention to the first articulated arm 230X, as illustrated in FIG. 11, respective portions 231X to 237X configuring the first articulated arm 230X employ a thin structure, the respective joint mechanisms 410X to 470X employ a small structure, and the first articulated arm 230 has a structure with a completely thin arm. However, a movable area and a work area of the first articulated arm 230X and a movable area and a work area of the second articulated arm 240 are the same as those of the robot 100 according to the first embodiment illustrated in FIGS. 3 to 7. In addition, as illustrated in FIGS. 9 and 10, the robot control device 900 controls the rotation of the respective joint mechanisms 410X to 470X of the first articulated arm 230X, and the rotation of the respective joint mechanisms 510 to 570 of the second articulated arm 240. In this manner, the first articulated arm 230X can be operated in the first arm movable area 230MS and the first arm work area 230WS which are described above, and the second articulated arm 240 can be operated in the second arm movable area 240MS and the second arm work area 240WS which are described above.

According to the robot 100X according to the invention, the first articulated arm 230X having the different structure can also be more easily recognized. Accordingly, it becomes easy to predict the approach or contact of the respective first articulated arms 230X, and it becomes easy to avoid contact. Therefore, it is possible to improve safety in the work, and it is possible to achieve further improved smooth work.

It is possible to reduce the weight of the first articulated arm 230X by the first articulated arm 230X employing the structure with the completely thin arm. If the first articulated arm 230X comes into contact with the worker 1000, it is possible to reduce the force applied to the worker 1000, and thus it is possible to improve safety. In addition, it is possible to reduce the force (torque) for rotating the respective joint mechanisms or the rotating speed for the respective joint mechanism or for the overall first articulated arm 230X by the respective joint mechanisms 410X to 470X employing the small structure. If the first articulated arm 230X comes into contact with the worker 1000, it is possible to reduce the force applied to the worker 1000, and thus it is possible to improve safety.

### D. Modification Example

### 1. Modification Example 1

With regard to the robot 100 (refer to FIG. 1) according to the above-described first embodiment, as an example of a difference in the appearance between the first articulated arm 230 and the second articulated arm 240, a case has been described where the surface patterns of the arms are different from each other since the stripe pattern is drawn on the outer surface of the first articulated arm 230. However, the difference in the appearance between the first articulated arm 230 and the second articulated arm 240 is not limited to the surface patterns of the arms. The examples include at least one of various differences in the appearance, such as an arm length, an arm thickness, an arm surface shape, an arm surface color, an arm surface pattern the number of arm joints, an arm joint shape, a shape of accessory components disposed on an arm surface, an arrangement of the accessory components, and the number of the accessory components. That is, the examples are not particularly limited as long as the first articulated arm 230 has an appearance which is different from that of the second articulated arm 240 so as to more easily recognize the first articulated arm 230 and so as to attract attention to the first articulated arm 230 from the worker 1000. The difference in the appearance between the first articulated arm 230 and the second articulated arm 240 enables the worker 1000 to easily recognize the first articulated arm 230, and to easily predict the approach and contact of the first articulated arm 230. Accordingly, the safety of the worker 1000 can be improved. In addition, since the first articulated arm 230 can be more easily recognized, the worker 1000 can concentrate further on the work while concentrating less on the first articulated arm 230. In this manner, it is possible to carry out further improved smooth work.

### 2. Modification Example 2

With regard to the robot 100X (refer to FIG. 11) according to the above-described second embodiment, as an example of a structural difference between the first articulated arm 230X and the second articulated arm 240, a case has been described where the first articulated arm 230X employs a thinner arm than the second articulated arm 240. However, examples of the structural difference between the first articulated arm 230X and the second articulated arm 240 are not limited to the arm thickness, and include at least one of differences in various structures such as an arm length, an arm thickness, an arm surface shape, the number of arm joints, a movable angle of joints, plasticity or flexibility of an arm, a drive mechanism for driving an arm, and a motor included in the drive mechanism. That is, the examples are not particularly limited as long as the first articulated arm 230X has a structure which is different from that of the second articulated arm 240 so as to more easily recognize the first articulated arm 230X and so as to attract attention to the first articulated arm 230X from the worker 1000. The structural difference between the first articulated arm 230X and the second articulated arm 240 enables the worker 1000 to easily recognize the first articulated arm 230X, and to easily predict the approach and contact of the first articulated arm 230X. Accordingly, the safety of the worker 1000 can be improved. In addition, since the first articulated arm 230X can be more easily recognized, the worker 1000 can concentrate further on the work while concentrating less on the first articulated arm 230X. In this manner, it is possible to carry out further improved smooth work.

If the structure of the first articulated arm 230X employs a structure having improved plasticity or flexibility of the arm, even if the first articulated arm 230X comes into contact with the worker 1000 or another robot, it is possible to reduce the force applied due to contact, and thus it is possible to improve safety. In addition, if the first drive mechanism of the first articulated arm 230X employs a drive mechanism having a structure for further reducing the operation speed or the generated force as compared to the second drive mechanism of the second articulated arm 240, the worker 1000 is likely to avoid contact, and thus, it is possible to improve safety of the worker 1000. In addition, even the first articulated arm 230X comes into contact with the worker 1000 or another robot, it is possible to reduce the force applied due to contact, and thus, it is possible to improve safety.

### 3. Modification Example 3

With regard to the robot 100 according to the first embodiment, a case has been described where the first articulated arm 230 and the second articulated arm 240 employ the same structure, and are controlled in a state where the movable areas and the work areas are different from each other by respectively and differently controlling the operation states of the first drive mechanism of the first articulated arm 230 and the second drive mechanism of the second articulated arm 240. However, without being limited thereto, the movable areas and the work areas may be respectively brought into different states by the first articulated arm 230 and the second articulated arm 240 respectively employing different structures. For example, the movable areas and the work areas may be respectively brought into different states by causing the joint mechanisms 410 to 470 of the first articulated arm 230 and the joint mechanisms 510 to 570 of the second articulated arm 240 to have partially or entirely different physical rotatable ranges. This modification is also similarly applied to the robot 100X according to the above-described second embodiment.

### 4. Modification Example 4

Preferably, the operation speed of the first articulated arm 230 is set to be from 10% to 70% of the operation speed of the second articulated arm 240, and more preferably is set to be from 20% to 50%. In this manner, the worker 1000 can feel comfortable as described above while the worker 1000 enables the first articulated arm 230 to sufficiently carry outwork. For example, the “operation speed of the articulated arm” means an average value (average operation speed) of the angular speed of each joint mechanism of the articulated arm. However, without being limited thereto, the operation speed may be the fastest angular speed of the joint. In addition, the operation speed may be movement speed of a distal end portion of the arm. The operation speed may be expressed by a parameter representing the arm moving speed.

For example, in order to cause the operation speed of the first articulated arm 230 to be slower than the operation speed of the second articulated arm 240, a voltage to be applied to the motors 411 to 471 of the first articulated arm 230 is set to be smaller than a voltage to be applied to the motors 511 to 571 of the second articulated arm 240. In this manner, as described above, it is possible to obtain a more advantageous effect while allowing the robot 100 to be excellent in safety. The voltage to be applied may be a rated voltage of the motors, that is, a voltage which is applicable to the motors. In addition, the voltage may be a control voltage to be actually applied to the applicable voltage.

The following advantageous effects can be obtained by causing the voltage to be applied to the motors 411 to 471 of the first articulated arm 230 to be smaller than the voltage to be applied to the motors 511 to 571 of the second articulated arm 240. The rotation speed of the motors 411 to 471 is enabled to be slower than the rotation speed of the motors 511 to 571. That is, the number of rotations of the motors 411 to 471 is enabled to be smaller than the number of rotations of the motors 511 to 571. This can decrease the wear amount of the motors 411 to 471, thereby allowing the motors 411 to 471 to have prolonged durability. In addition, a current flowing in the motors 411 to 471 can be lower than a current flowing in the motors 511 to 571. This can cause a heat generation amount of the motors 411 to 471 to be smaller than a heat generation amount of the motors 511 to 571, and thus it is possible to prevent failure or deterioration which may be caused by heat generation of the first articulated arm 230. Furthermore, a rated torque of the motors 411 to 471 can be smaller than a rated torque of the motors 511 to 571. In this manner, for example, when the first articulated arm 230 and the second articulated arm 240 collide with each other due to effects of an earthquake, the first articulated arm 230 is broken prior to the second articulated arm 240. Therefore, it is possible to reuse the robot 100 by replacing or repairing only the first articulated arm 230.

### 5. Modification Example 5

In the above-described embodiments, a motor for driving one articulated arm between two articulated arms and a motor for driving the other articulated arm have the same configuration. However, without being limited thereto, motors having different rotation speed or torques may be respectively mounted on each articulated arm in advance. In this manner, even when the robot control device applies an equal voltage to each articulated arm, each articulated arm is enabled to have different operation ranges and different operation speeds.

### 6. Modification Example 6

In the robots (double arm robot) 100 and 100X according to the above-described embodiments, the first articulated arms 230 and 230X or the trunk 220 may include at least one detection unit which detects the presence or absence of a worker or another robot (hereinafter, referred to as a worker or the like) carrying out work in a work area (joint work area DWSa) beside or in front of the robots 100 and 100X. For example, the stereo camera 250 can be used as the detection unit. A dedicated detection sensor or camera may be included therein separately from the stereo camera 250. Then, when the detection unit is switched from a detection state (state where a worker is present) to a non-detection state (state where a worker is absent), the robot control device 900 may stop the operation of the robot by stopping the operation of the first articulated arms 230 and 230X and the second articulated arm 240. In this case, when the worker or another robot carrying out the work in the work area is absent, the operation of the robot is stopped. Accordingly, it is possible to exclude an unnecessary operation which continues regardless when the worker or another robot carrying out joint work is absent.

When the detection unit is switched from the non-detection state to the detection state, the robot may restart the operation. In this case, when the worker or another robot carrying out the work in the work area is present, the robot control device 900 restarts the operation of the robot. Accordingly, it is possible to improve work efficiency.

The detection unit (for example, a detection sensor or camera using infrared rays) which detects the presence or absence of an object around the robot, for example, behind the trunk 220 may be included therein. When the detection unit is in the detection state, the robot control device 900 may stop the operation of the robot by determining that something or someone other than a worker is present. According to this configuration, it is possible to avoid a case where a person other than the worker cuts in around the robot and comes into contact with the robot when the robot carries out work. Therefore, it is possible to improve safety.

### 7. Modification Example 7

In the above-described embodiments, a case has been described as an example where the robot 100 jointly carries out work with a worker or another robot arranged beside or in front of the robot 100, but the embodiment is not limited thereto. The embodiment can also be advantageously applied to a case where the robot 100 carries out the work alone, as long as the right and left arms respectively have different appearances or structures. For example, when an abnormality occurs in the robot main body 200, a worker may want to stop the operation by pressing the emergency stop button 214 in some cases. In this case, the worker is likely to approach the robot 100 while paying attention to one arm (first articulated arm 230) which is highly visible. Therefore, there is an advantage in that the worker can quickly cope with the abnormality.

### 8. Modification Example 8

In the above-described embodiments, the number of joints in each arm of the robot is seven. However, without being limited thereto, the number of joints in each arm may be any desired number, such as three or more. In addition, in the above-described embodiments, a case has been described where the robot carries out assembling work. However, without being limited thereto, the invention can be applied to various work tasks such as a screwing process for components.

Without being limited to the above-described embodiments or the modification examples, the invention can be embodied through various configurations within the scope not departing from the gist thereof. For example, technical features in the above-described embodiments or the modification examples which correspond to technical features in respective forms described in the summary of the invention can be appropriately replaced or combined with each other in order to partially or completely solve the above-described problems or in order to partially or completely achieve the above-described object. In addition, the technical features can be appropriately deleted unless described as essential in this description.

The entire disclosure of Japanese Patent Application No. 2014-155646, filed Jul. 31, 2014 is expressly incorporated by reference herein.

What is claimed is:

1. A double arm robot comprising:
a first arm to which a first end effector is attached; and
a second arm to which a second end effector is attached,
wherein the first arm and the second arm are different from each other in at least one of an arm length, an arm thickness, an arm surface shape, an arm surface color, an arm surface pattern, the number of arm joints, an arm joint shape, a shape of accessory components disposed on an arm surface, an arrangement of the accessory components, and the number of the accessory components.

2. The double arm robot according to claim 1,
wherein a size of a work area for the first arm is different from a size of a work area for the second arm.

3. The double arm robot according to claim 2,
wherein the work area of the first arm overlaps a portion of a work area of a worker or another robot, which is disposed beside or in front of the first arm, and the work area of the second arm does not overlap the work area of the worker or another robot.

4. The double arm robot according to claim 2, further comprising:
a first drive mechanism that drives the first arm; and
a second drive mechanism that drives the second arm,
wherein a size difference between the work area of the first arm and the work area of the second arm is made due to a difference between the first drive mechanism and the second drive mechanism.

5. The double arm robot according to claim 2 further comprising:
a control unit that controls each operation of the first arm and the second arm,
wherein a size difference between the work area of the first arm and the work area of the second arm is made due to a difference between the control of the first arm and the control of the second arm by the control unit.

6. A double arm robot comprising:
a first arm to which a first end effector is attached; and
a second arm to which a second end effector is attached,
wherein the first arm and the second arm are different from each other in at least one of an arm length, an arm thickness, an arm surface shape, the number of arm joints, a movable angle of a joint, arm plasticity or flexibility, a drive mechanism for driving the arm, and a motor included in the drive mechanism, and
wherein a size of a work area for the first arm is different from a size of a work area for the second arm.

7. The double arm according to claim 6,
wherein the work area of the first arm overlaps a portion of a work area of a worker or another robot, which is disposed beside or in front of the first arm, and the work area of the second arm does not overlap the work area of the worker or another robot.

8. The double arm according to claim 6, further comprising:
a first drive mechanism that drives the first arm; and
a second drive mechanism that drives the second arm,
wherein a size difference between the work area of the first arm and the work area of the second arm is made due to a difference between the first drive mechanism and the second drive mechanism.

9. The double arm robot according to claim 6, further comprising:
a control unit that controls each operation of the first arm and the second arm,
wherein a size difference between the work area of the first arm and the work area of the second arm is made due to a difference between the control of the first arm and the control of the second arm by the control unit.

10. The double arm robot according to claim 1, further comprising:
a base; and
a trunk that is rotatably connected to the base,
wherein the first arm and the second arm are respectively connected to the trunk on both sides of the trunk.

11. The double arm robot according to claim 6, further comprising:
a base; and
a trunk that is rotatably connected to the base,
wherein the first arm and the second arm are respectively connected to the trunk on both sides of the trunk.
